(19) United States
(12) Patent Application Publication
(10) Pub. No.: US 2003/0043190 A1
(43) Pub. Date: Mar. 6, 2003

(54) Website chat room having images displayed simultaneously with interactive chatting

(75) Inventors: Matthew H. Bernius, Rochester, NY (US); Thomas J. Hoehn, Rochester, NY (US)

Correspondence Address: Thomas H. Close, Eastman Kodak Company, Patent Legal Staff, 343 State Street, Rochester, NY, 14650-2201, US

(73) Assignee: Eastman Kodak Company

(21) Appl. No.: 09/944,551

(22) Filed: Aug. 31, 2001

(51) Int. Cl. G09G 5/00

(52) U.S. Cl. 345/753; 345/758; 345/759

(57) ABSTRACT

A website for providing interactive communication between first and second users comprises displayable text provided by the first user which text is input and subsequently displayed in real time; displayable text provided by the second user which text is input and subsequently displayed in real time; and an image provided by the first user, which are input and subsequently displayed in real time so that the first user shares viewing of the image with the second user.

### FIELD OF THE INVENTION

The invention relates generally to the field of interactive chat rooms on the Internet and, more particularly, to such chat rooms having replaceable images displayed along with corresponding text.

### BACKGROUND OF THE INVENTION

Currently known and utilized chat rooms on the Internet include text input by two or more users usually located at different locations. This text is subsequently displayed on a real-time basis for providing a viewable transcript of the written conversation. This interactive displayable text is commonly referred to as chatting. In one form of chatting, a well-known celebrity or subject matter expert (SME) provides a portion of the text. These chat rooms also display the nicknames of the users so that a real time display of current users of the chat room is available.

Although the currently known and utilized chat rooms are satisfactory, they include drawbacks. It is a slogan that an image produces 1000 words. In this regard, the currently and utilized chat rooms do not provide for interactive display of images. This obviously limits the usefulness of such chat rooms.

Consequently, a need exists for chat rooms having interactive display of images.

### SUMMARY OF THE INVENTION

The present invention is directed to overcoming one or more of the problems set forth above. Briefly summarized, according to one aspect of the present invention, the invention resides in a website for providing interactive communication between first and second users comprising (a) displayable text provided by the first user which text is directly or indirectly input and subsequently displayed in real time; (b) displayable text provided by the second user which text is input and subsequently displayed in real time; and (c) an image provided by the first user, which are directly or indirectly input and subsequently displayed in real time so that the first user shares viewing of the image with the second user.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of permitting of images to be inserted into interactive chat rooms. The present invention also has the advantage of permitting the images to be changed so that the images and text correspond to each other. Still further, the present invention includes the advantage of permitting high resolution versions of the images to be obtained for permitting enhanced viewing of the images.

### BRIEF DESCRIPTION OF THE DRAWINGS

FIG. 1 is a perspective view of a computer system for implementing the present invention thereon; and

FIG. 2 is a graphical illustration of a chat room.

### DETAILED DESCRIPTION OF THE INVENTION

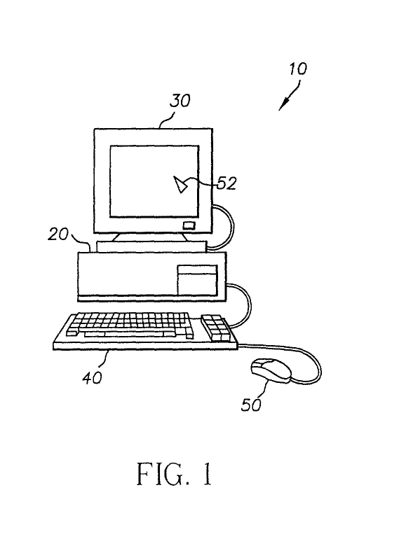

Referring to FIG. 1, there is illustrated a computer system 10 for implementing the present invention. Although the computer system 10 is shown for the purpose of illustrating a preferred embodiment, the present invention is not limited to the computer system 10 shown, but may be used on any electronic processing system. The computer system 10 includes a microprocessor-based unit 20 for receiving and processing software programs and for performing other processing functions. A display 30 is electrically connected to the microprocessor-based unit 20 for displaying user-related information associated with the software. A keyboard 40 is also connected to the microprocessor based unit 20 for permitting a user to input information to the software. As an alternative to using the keyboard 40 for input, a mouse 50 may be used for moving a selector 52 on the display 30 and for selecting an item on which the selector 52 overlays, as is well known in the art.

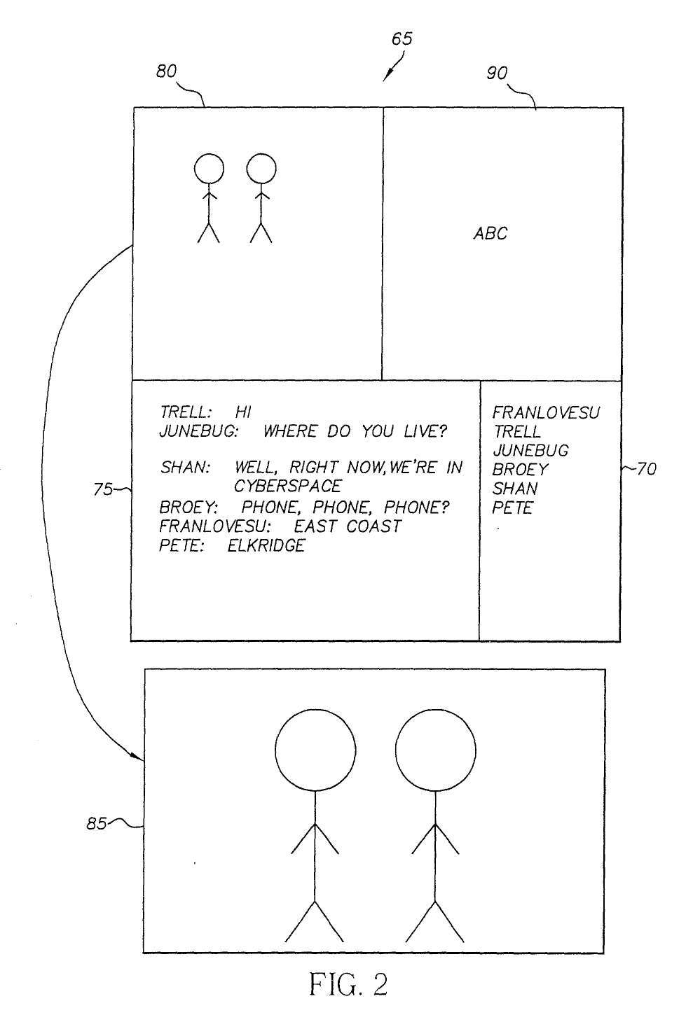

Referring to FIG. 2, there is shown a chat room 65 of a website of the present invention. A predetermined portion 70 of the chat room 65 is designated for Internet nicknames and the like. In this regard, the Internet nicknames of each user currently using the chat room 65 are displayed in the predetermined portion 70. A text display portion 75 is adjacent the predetermined portion 70 and displays written text input by the users. In one embodiment, one of the users is a well-known celebrity or subject matter expert (SME) in which the other users ask questions and the like of the celebrity. To ask a question, the user from a remote terminal, such as a computer 10 at a residence, inputs via a user interface 40 and 50 the question to be asked of the celebrity or SME. This is sent to the website over the Internet and the website displays the user name along with the associative question. Likewise, the celebrity or SME responses to the question by inputting text into their computer 10 via a user interface 40 and 50, or by requesting the operator of the website to input text directly via interface 40 and 50. This response is also sent to the website over the Internet for display of the celebrity's or SME's name and corresponding response.

The website also includes an image display portion 80 in which an image is input by an operator of the website. The operator has available a plurality of images, and the operator selects an image based upon current conversation between the celebrity or SME and users. Alternatively, the celebrity or SME may input the images. When the discussion changes, the operator replaces the current image with another image representative of the current discussion. The operator replaces the images as many times as deemed desirable. Those skilled in the art will recognize that, in lieu of the operator inputting an image, the user may send images or the Internet for display in the chat room.

The user may place the selector 52 of their computer 10 on the image and click the mouse for requesting the image to be enlarged. The website receives his request and displays the enlarged version of the image 85 to the user.

A caption area 90 is also disposed on the chat room 65 for permitting a summary of the image to be presented by the operator. The summary 90 would preferable be replaced with different text substantially simultaneously with the replacement of the images. Alternatively, the celebrity or SME may send the summary over the Internet to the operator for input and display.

It is to be understood that the website of the present invention uses software for its operation, and such software is readily reproduced by those skilled in the art from a reading of the above description.

The invention has been described with reference to a preferred embodiment. However, it will be appreciated that variations and modifications can be effected by a person of ordinary skill in the art without departing from the scope of the invention.

### PARTS LIST

10 computer system

20 microprocessor-based unit

30 display

40 keyboard

50 mouse

52 selector

65 chat room

70 predetermined portion

75 text portion

80 image display portion

85 image

90 caption area

What is claimed is:

1. A website for providing interactive communication between first and second users comprising:
(a) displayable text provided by the first user which text is directly or indirectly input and subsequently displayed in real time;
(b) displayable text provided by the second user which text is input and subsequently displayed in real time; and
(c) an image provided by the first user, which are directly or indirectly input and subsequently displayed in real time so that the first user shares viewing of the image with the second user.

2. The website as in claim 1 further comprising a subsequent image that replaces the image for permitting enhanced interactive chatting.

3. The website as in claim 2, wherein the image or subsequent image is enlarged in size when requested by the first or second user.

4. The website as in claim 2 further comprising descriptive text of the image or subsequent image displayed on a real time basis substantially simultaneously with the image or subsequent image.

5. The website as in claim 2 further comprising storing the text of the first and second user along with lower resolution versions of the image and/or any subsequent image for forming a transcript for ultimately permitting archival and later retrieval of the transcript.

6. The website as in claim 5 further comprising higher resolution versions of the lower resolution versions of the image or subsequent image which are also stored.

7. The website as in claim 6 further comprising a link between the lower resolution and higher resolution images.
